(19) United States
(12) Patent Application Publication
(10) Pub. No.: US 2013/0255814 A1
(43) Pub. Date: Oct. 3, 2013

(54) Permanent Inlet Flow Restrictor Assembly

(71) Applicants: Charles H. Graham, JR., St. Catharines (CA); Ana Piller, St. Catharines (CA)

(72) Inventors: Charles H. Graham, JR., St. Catharines (CA); Ana Piller, St. Catharines (CA)

(21) Appl. No.: 13/435,622

(22) Filed: Mar. 30, 2012

(51) Int. Cl. F16L 55/027

(52) U.S. Cl. 138/40

(57) ABSTRACT

A flow restrictor assembly which is to be custom fitted to the inside of catch basins attached to storm sewer systems, which flow restrictor assembly is sized so as to restrict the amount of fluid which can flow through the flow restrictor, and which has a hatch which can be easily lifted to allow for easy cleaning and maintenance of the catch basin.

### TECHNICAL FIELD

The present invention relates to flow restrictors and more specifically to low head flow restrictors for catch basins attached to storm sewers. The restrictors sit on top of the catch basin just below the grate and can easily be opened without removing them from the catch basin to allow users to easily access the interior of the catch basin for cleaning and maintenance purposes.

### BACKGROUND OF THE INVENTION

Many basement drains from homes and other buildings are connected directly to storm sewers and, in some cases, basement drains are connected to the catch basins. A heavy rainstorm can overwhelm the storm sewers, causing basements to flood. It can also overwhelm treatment plants.

In addition, while most sewer systems that have been installed for the last several decades have had separate systems for the sanitary and the storm water, many older municipalities have a combined sewer system, in which sanitary waste water and storm water are carried through the same pipes. In combined sewer systems, the waste water and storm water all goes to a treatment plant to be treated before discharge. In municipalities with combined sewer systems a heavy rainstorm can overwhelm the treatment plant. In these cases, the water from the treatment plant is often discharged untreated or only partially treated. This can create public health issues as the water being discharged is not just storm water, but is mixed with sanitary waste. The sanitary waste can contain bacteria and toxic chemicals.

Catch basins are often an integral part of a storm sewer system in both separate and combined systems. Catch basins in storm sewer systems usually have a grate at the top to prevent large solids and debris from entering the system. The catch basin itself holds some solids and keeps them out of the system, but the catch basin must be cleaned periodically to remove the accumulated solids. One common way of cleaning catch basins is to remove the grate at the top of the catch basin and pump out the waste and solids contained within it. Existing products (low head inlet control devices) on the market such as the Catch Flow Restrictor with Opening Calibrated to Flow and Head Pressure, U.S. Pat. No. 5,032,264, (the '264 patent) restrict the flow to catch basins in the same manner as this invention does. However, the flow restrictor in the '264 patent is manufactured of an injection molded material which may be easily damaged. Additionally, it can't easily be opened and therefore, the catch basin below can't easily be cleaned.

### SUMMARY OF THE INVENTION

This invention provides a low head flow restrictor assembly to fit under the grating of a catch basin, where the catch basin opens to a sewer system. The invention restricts the amount of water which can enter the catch basin by restricting the flow and therefore prevents overloading of the sewer systems. In combined systems, where storm water and sanitary waste are carried through the same pipes, by restricting the flow to the storm sewer, it also prevents sewer treatment plants from overloading.

A hinge on the hatch of the invention allows easy access to the interior of the catch basin, thus facilitating the cleaning and maintenance of the catch basin. The current invention can be made of sturdy and durable material such as a corrosion resistant material, for example, 316 stainless steel, so it will not be degraded by exposure to the elements. This invention is customizable to achieve a good fit regardless of the size of the catch basin, the frame type and the grate type.

The invention can be made with a variety of aperture sizes, each of which allows different amounts of water to flow through the restrictor in a given amount of time, thus restricting the flow rate of water into the system to a predetermined amount. This invention will enable municipalities and other entities that operate storm water systems to restrict the flow of storm water entering the storm sewer system by allowing the water to gather temporarily in the area surrounding and above the catch basins so that it will not be more than sewer lines can handle. This will minimize or eliminate the flooding of basements that are connected to either the sewer system or the catch basin and, in the case of combined systems, it will also prevent the treatment plants from overloading.

### BRIEF DESCRIPTION OF THE FIGURES

FIG. 1 is a top view of the invention.

FIG. 2 is a perspective view of the invention.

FIG. 3 is a cross-sectional side view of the invention as viewed from line a-a in FIG. 1.

FIG. 4 is a cross-sectional side view of the invention as viewed from line b-b in FIG. 1, with the hatch in a closed position, with the invention in place in a catch basin.

FIG. 5 is a cross-sectional side view of the invention as viewed from line b-b in FIG. 1, with the hatch in an open position.

FIG. 6 is a cross-sectional view of the junction of the frame assembly and the hatch showing the gasket.

### DETAILED DESCRIPTION

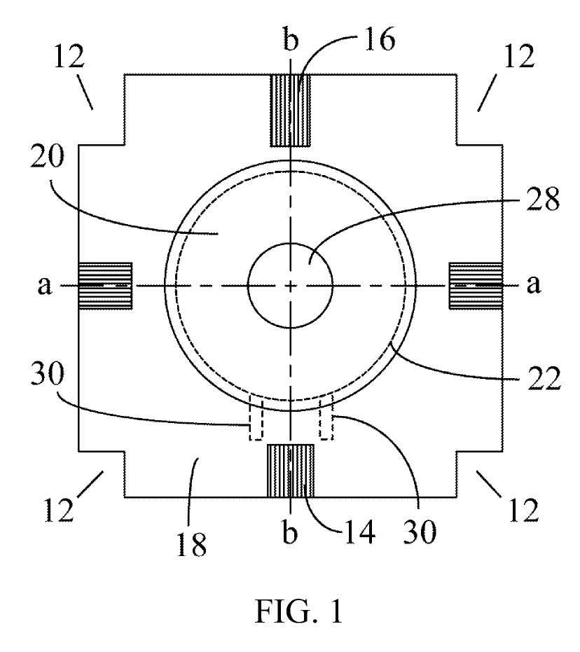

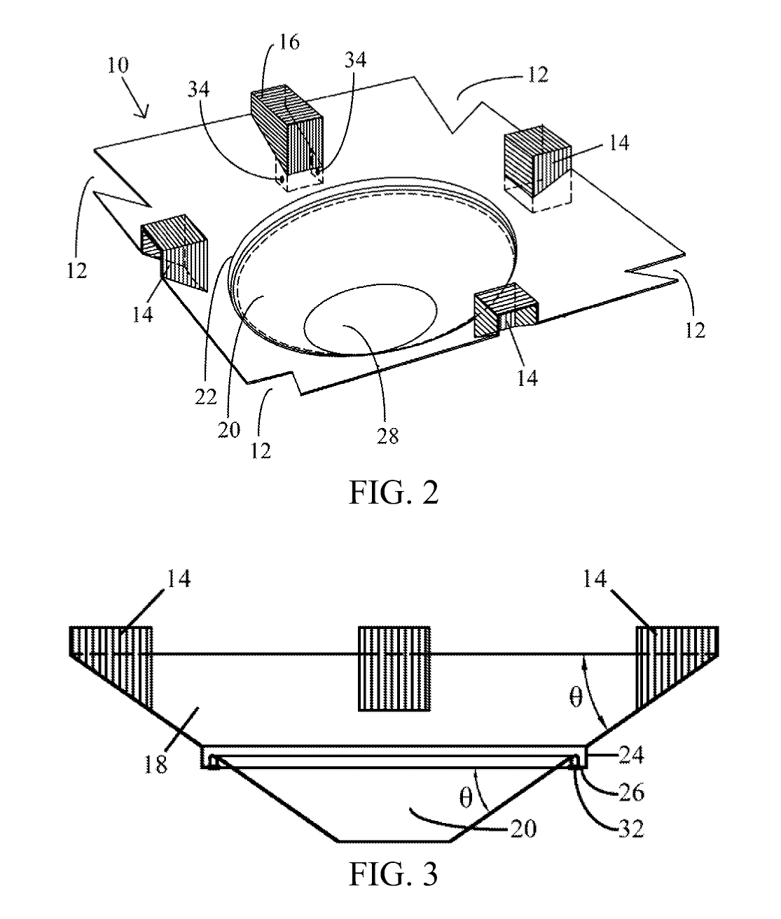

FIGS. 1 and 2 show the flow restrictor assembly of this invention, shown generally at 10, which is to be installed in a catch basin 40. In one embodiment, the flow restrictor assembly is made of 316 stainless steel, thus providing superior corrosion resistance, and enabling the flow restrictor assembly to be impervious to salt and other corrosive or damaging compounds that may wash down the sewer. However, the flow restrictor assembly can be made from a variety of other materials, such as plastics or other metals or alloys. A thickness of ⅛ inch will allow the flow restrictor to be sturdy enough that it will be able to withstand impingements of any debris or other substance that may be carried through the grate that sits above the flow restrictor assembly, although the flow restrictor assembly may be made thicker or thinner.

The flow restrictor assembly has two sections: a frame assembly 18 and a hatch 20. The frame assembly 18 is generally in the shape of a rectangle. In the embodiment shown, the frame assembly 18 is a 600 mm by 600 mm square, but other sizes and shapes can be used. The frame assembly can have a rectangular shape 12 cut out from each of the junctions of two adjacent exterior edges of the frame assembly. Although the rectangular cutouts 12 can be the same size as each other, they need not be. In the embodiment shown, two of the rectangular cutouts are 65 mm square, while the opposing two rectangular cutouts are 65mm by 100 mm, although other sizes of cutouts can be used.

Many catch basins have a lip (not shown) that runs along the inner perimeter of the wall a short distance below the top surface of the catch basin. The lip may have raised protrusions at each corner or roughly in the center of the perimeter of each wall or both. The protrusions are sturdy enough to support a grate 38 and the grate may rest on the protrusions. The grate 38 is designed to prevent large pieces of debris from entering the catch basin. The rectangular cutouts 12 in the flow restrictor assembly 10 allow the flow restrictor assembly to fit into a catch basin that has protrusions in the corners, allowing the flow restrictor assembly 10 to rest directly on the lip of the catch basin, without allowing raised protrusions in the corners on the lip in the corners of the catch basin to interfere with the flow restrictor assembly 10.

The flow restrictor assembly can have raised saddles 14, 16 roughly in the center of each side of the outer perimeter of the flow restrictor assembly 10. The saddles 14, 16 are designed to provide a good fit to the catch basin frame However, in some cases, for example, some ditch catch basins where there are no raised protrusions inside the perimeter of the catch basin, saddles may not be required to achieve a good fit. In these cases, saddles may be omitted. The saddles 14, 16 allow the flow restrictor assembly to rest above any raised protrusions that are located in the perimeter wall of the catch basin, and the grate can then rest on these saddles 14, 16. Thus, the flow restrictor assembly 10 can rest on the internal lip inside the catch basin without raised protrusions along the perimeter wall interfering with it. The sewer grate will rest either on top of the flow restrictor assembly, or on top of raised protrusions in the corners of the catch basin. One of the saddles 16 extends both above and below the surface of the frame assembly. Holes 34 in the portion of the raised saddle 16 which extends below the surface of the frame assembly allow the flow restrictor assembly to be attached to the catch basin with bolts, screws or other methods of attachment.

The boundary between the flow restrictor assembly and the catch basin can be sealed with adhesive or a similar substance to minimize water incursion around the edges of the flow restrictor assembly. In one embodiment, the boundary between the flow restrictor assembly and the lip of the catch basin is sealed with roofing sealing compound, although other compounds, for example, caulk can be used, or the flow restrictor assembly can rest directly on top of the lip of the catch basin, without a sealant layer.

The frame assembly 18 of the flow restrictor assembly 10 has an outer shape roughly the same as and slightly smaller than the interior shape of the catch basin where the flow restrictor assembly is to be installed. Thus, the flow restrictor assembly 10 can fit easily but snugly within the catch basin and rest on the lip of the catch basin. Catch basins come in a limited number of shapes and sizes, and the flow restrictor assembly 10 can be made in shapes and sizes to fit into a variety of catch basins. They can also be made to order if a catch basin is of a non-standard size. In the embodiment shown in FIG. 1, the frame assembly has exterior edges that are generally equal in size, in order to be inserted into a four-sided square catch basin. In this embodiment, the dimensions of the frame assembly are 600 mm by 600 mm, but other dimensions can be used, to fit different catch basins. If a catch basin were to have a different number of sides or a different shape, such as a rectangular shape, the frame assembly would accordingly also have a different number of exterior edges or a different shape.

As shown in FIG. 3, the frame assembly 18 slopes downward from the outermost edge of the frame assembly toward the center or innermost edge of the frame assembly 10 at an angle θ from the horizontal. In the embodiment shown, θ is 35 degrees, but θ can be other angles ranging from 15 to 70 degrees but preferably ranges from 20 to 50, or more preferably, from 30 to 40 degrees. The innermost edge of the frame assembly defines a circular opening or hole 22 roughly in the center of the frame assembly.

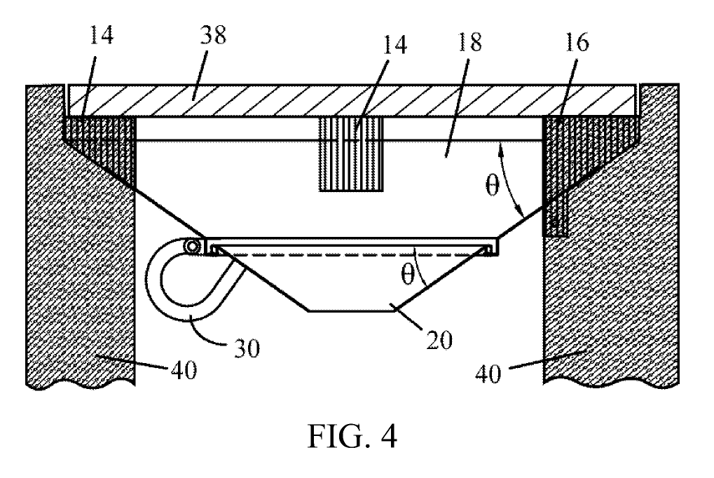

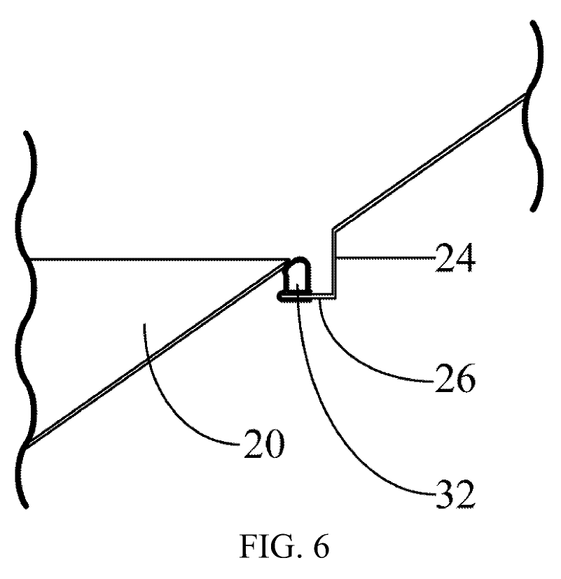

As shown in FIGS. 4, 5 and 6, the interior edge of the frame assembly 18 around the hole 22 has a vertical ring 24 attached to and extending below it. The vertical ring 24 has a top edge and a bottom edge. The top edge of the vertical ring 24 is attached to the edge of the frame assembly which defines the hole 22. The outer edge of a horizontal ring 26 is attached to the bottom edge of the vertical ring 24 and extends horizontally in a direction generally toward the center of the circular opening of the frame assembly 18 and further defines the hole 22. The horizontal ring 26 is narrow; in one embodiment, being 15 mm wide, although it can be somewhat wider or narrower, typically ranging from 8 to 20 mm wide, but possibly as much as 35 mm wide.

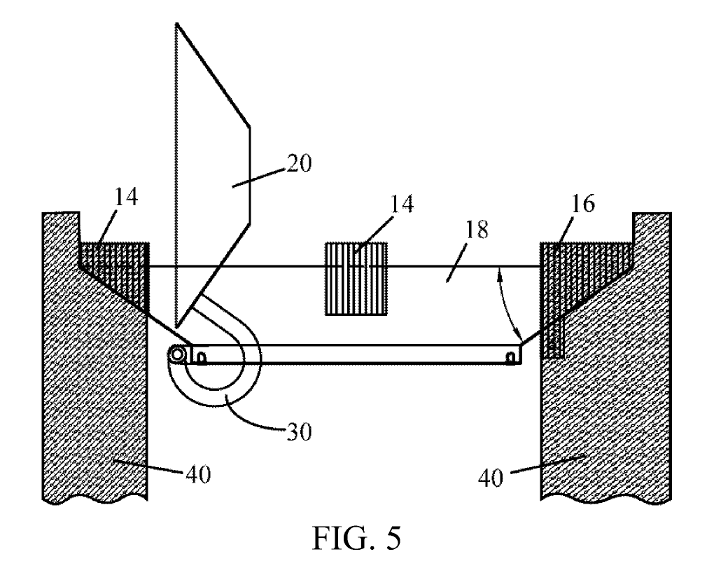

One end of each of a plurality of hinges 30 is attached to the frame assembly, preferably attached to the exterior portion of the vertical ring 24 of the frame assembly, although the hinges can also be directly attached to one of the surfaces of the frame assembly. The second ends of the hinges 30 are attached to the hatch 20, in a manner which allows the hatch to be raised when pulled up. This allows the hatch to be swung open to allow for cleaning or maintenance of the catch basin without having to remove the flow restrictor assembly from the catch basin. The hatch in FIG. 4 is in a closed position, while FIG. 5 shows the hatch 20 in an open position.

When in the closed position, the walls of the hatch 20 slope downward from the horizontal at an angle θ, which is roughly the same angle θ at which the frame assembly slopes downward from the horizontal. The hatch is sized so that its outermost edges define an area that is slightly larger than the inner dimensions of the horizontal ring 26 of the frame assembly, thus allowing the hatch to rest on the frame assembly. A gasket 32 is attached to the inner edge of the horizontal ring 26, and to the outer edge of the hatch 20, forming a seal between them. The innermost edges of the hatch define a circular opening or hole 28. The size of the circular opening 28 can vary depending on the desired maximum water flow rate through the flow restrictor assembly 10, with different sized circular openings being associated with different flow rates. Table 1 below shows examples of the different flow rates for different sized circular openings with a water head pressure of 30 cm above the ground. The actual opening size can vary from those in Table 1. In some cases, the actual opening size can be even larger than 21 cm as determined by system or cleaning and maintenance needs.

TABLE 1

| Opening Diameter (cm) | Water Flow Rate (lit/sec) |
|---|---|
| 7.5 | 11 |
| 9.0 | 16 |
| 10.5 | 21 |
| 12.0 | 27 |
| 15.0 | 41 |
| 18.0 | 57 |
| 21.0 | 75 |

While a preferred form of this invention has been described above and shown in the accompanying drawings, it should be understood that applicant does not intend to be limited to the particular details described above and illustrated in the accompanying drawings, but intends to be limited only to the scope of the invention as defined by the following claims. In this regard, the terms as used in the claims are intended to include not only the designs illustrated in the drawings of this application and the equivalent designs discussed in the text, but are also intended to cover other equivalents now known to those skilled in the art, or those equivalents which may become known to those skilled in the art in the future.

What is claimed is:

1. A flow restrictor assembly comprising:
a frame assembly with inner and outer edges, and
a hatch with inner and outer edges,
wherein the inner edges of the frame assembly define a first hole and the inner edges of the hatch define a second hole, and the hatch is connected to the frame assembly with a plurality of hinges.

2. The invention as claimed in claim 1 in which the hatch, when in the closed position, partially covers the hole defined by the inner edges of the frame assembly.

3. The invention as claimed in claim 1 in which the flow restrictor assembly is made of 316 stainless steel.

4. The invention as claimed in claim 1 in which the flow restrictor assembly is ⅛ inch thick.

5. The invention as claimed in claim 1 in which the flow restrictor assembly is generally in the shape of a rectangle.

6. The invention as claimed in claim 5 in which the frame assembly has rectangular shapes cut out from each of the corners.

7. The invention as claimed in claim 5 in which the frame assembly has raised saddles roughly in the center of each of the outer perimeter of the flow restrictor assembly.

8. The invention as claimed in claim 7 in which one of the saddles extends below the plane of the frame assembly, and in which there are at least one hole in the portion of the saddle which extends below the plane of the frame assembly.

9. The invention as claimed in claim 8 in which bolts extend through the at least one hole in the portion of the saddle which extends below the plane of the frame assembly and through a portion of the wall of the catch basin.

10. The invention as claimed in claim 1 in which the hatch rests atop the inner edges of the frame assembly, and is supported by them.

11. The invention as claimed in claim 1 in which the flow restrictor assembly is configured so as to fit within a catch basin.

12. The invention as claimed in claim 11 in which the flow restrictor assembly rests upon an interior lip of a catch basin.

13. The invention as claimed in claim 12 in which the boundary between the flow restrictor assembly and the lip of the catch basin is sealed with a sealing compound.

14. The invention as claimed in claim 13 in which the sealing compound is roofing sealing compound.

15. The invention as claimed in claim 1 in which the walls of the frame assembly, when the frame assembly is in position within a catch basin, slope down from the horizontal at an angle.

16. The invention as claimed in claim 15 in which the slope of the walls of the frame assembly is an angle between thirty and forty degrees.

17. The invention as claimed in claim 1 in which the inner edges of the frame assembly define a circular opening.

18. The invention as claimed in claim 17 in which the upper edge of a vertical ring having an upper and a lower edge is attached to the inner edges of the frame assembly, and the vertical ring extends below the frame assembly.

19. The invention as claimed in claim 18 in which the exterior edges of a horizontal ring are attached to the lower edges of the vertical ring.

20. The invention as claimed in claim 1 in which the plurality of hinges each have a first side and a second side, where each of the first sides of the hinges are attached to the frame assembly and each of the second sides are attached to the hatch.

21. The invention as claimed in claim 1 in which the walls of the hatch, when the flow restrictor assembly is in position within a catch basin and the hatch is in a closed position, slope down from the horizontal at an angle.

22. The invention as claimed in claim 21 in which the angle is between thirty and forty degrees from the horizontal.

23. The invention as claimed in claim 1 in which a gasket is fits between the outer edges of the hatch and the inner edge of the horizontal ring of the frame assembly, sealing the joint between the hatch and the frame assembly.

24. The invention as claimed in claim 1 in which the inner edges of the hatch define a circular opening.

25. The invention as claimed in claim 24 in which the circular opening is sized to allow a predetermined amount of liquid to flow through the flow restrictor.
